(19) United States
(12) Patent Application Publication
(10) Pub. No.: US 2025/0368062 A1
(43) Pub. Date: Dec. 4, 2025

(54) POWER RECEIVING APPARATUS

(71) Applicant: DENSO CORPORATION, Kariya-city (JP)

(72) Inventors: Kazuhiro UDA, Kariya-city (JP); Shimpei TAKITA, Kariya-city (JP); Eisuke TAKAHASHI, Kariya-city (JP); Keisuke TANI, Kariya-city (JP)

(73) Assignee: DENSO CORPORATION, Kariya-city (JP)

(21) Appl. No.: 19/306,293

(22) Filed: Aug. 21, 2025

Related U.S. Application Data
(63) Continuation of application No. PCT/JP2024/005467, filed on Feb. 16, 2024.

(30) Foreign Application Priority Data
Feb. 21, 2023 (JP) 2023-024837

(51) Int. Cl. B60L 53/126; H02J 50/00; H02J 50/12; H02J 50/20; H02J 50/40; H02J 50/70; H02J 50/90

(52) U.S. Cl. CPC B60L 53/126; H02J 50/005; H02J 50/12; H02J 50/20; H02J 50/402; H02J 50/70; H02J 50/90

(57) ABSTRACT

A power receiving apparatus, to which power is to be wirelessly supplied from one or more power transmission apparatuses, is mountable to a mobile object that has a deformable portion. The power receiving apparatus includes a power receiving antenna unit mounted across the deformable portion of the mobile object. The power receiving antenna has flexibility, and is configured to be at least partly deformable in accordance with deformation of the mobile object.

### CROSS-REFERENCE TO RELATED APPLICATION

This application is a bypass continuation application of currently pending international application No. PCT/JP2024/005467 filed on Feb. 16, 2024 designating the United States of America, the entire disclosure of which is incorporated herein by reference, the international application being based on and claiming the benefit of priority from Japanese Patent Application No. 2023-024837 filed on Feb. 21, 2023, the disclosure of which is incorporated herein by reference.

### TECHNICAL FIELD

The present disclosure relates to power receiving apparatuses.

### BACKGROUND

There are various proposed technologies that wirelessly supply power from a power supply apparatus mounted to a road to a power receiving apparatus installed in a mobile object.

Such a power receiving apparatus includes a power receiving unit, i.e., a power receiving antenna unit, for receiving power supplied from the power supply apparatus. The power receiving unit is typically mounted on the bottom surface of the mobile object, so that the power receiving unit may come into contact with the road surface.

From this viewpoint, Japanese Patent Application Publication No. 2014-128124 discloses a technology that the rear end of the housing of the power receiving unit has a curved shape that reduces physical interference between the power receiving unit and the road surface.

Known automatic guided vehicles (AGVs), which are an example of these mobile objects, operate based on wirelessly supplied power. To continue stable traveling on a step or over an obstacle, one type of AGVs is comprised of two separate bodies aligned along its longitudinal direction and a joint portion that connects the two separate bodies. Such an AGV is configured such that each of the two separate bodies can be deformed, i.e., bent, in the vertical direction at the joint portion.

### SUMMARY

Arrangement of the power receiving unit in the joint portion of such an AGV may result in the power receiving unit being damaged due to deformation of the AGV. Such an issue may commonly occur in various mobile objects, each of which includes a joint portion.

For a mobile object with no joint portion, arrangement of the power receiving unit in a portion of the mobile object, which is likely to be deformed when the mobile object is ascending or descending a step or riding over an obstacle, may result in the power receiving unit being damaged.

For the above reasons, it is desired to achieve a technology that suppresses a damage to a mobile object due to deformation of the mobile object.

The present disclosure can be achieved as first and second exemplary aspects described hereinafter.

A power receiving apparatus according to the first exemplary aspect of the present disclosure, to which power is to be wirelessly supplied from one or more power transmission apparatuses, is mountable to a mobile object that has a deformable portion. The power receiving apparatus includes a power receiving antenna unit mounted across the deformable portion of the mobile object. The power receiving antenna has flexibility, and is configured to be at least partly deformable in accordance with deformation of the mobile object.

The power receiving antenna unit according to the first exemplary aspect is mounted across the deformable portion of the mobile object. The power receiving antenna has flexibility, and is configured to be at least partly deformable in accordance with deformation of the mobile object.

As compared with a power receiving apparatus with a power receiving antenna unit that does not have flexibility, the power receiving apparatus of the first exemplary aspect makes it possible to suppress damage to the power receiving antenna unit caused by deformation of the mobile object.

The power receiving apparatus includes the power receiving antenna unit that is mounted across the deformable portion, making it possible to prevent restrictions on the mount position of the power receiving antenna unit.

A power receiving apparatus according to the second exemplary aspect of the present disclosure, to which power is to be wirelessly supplied from one or more power transmission apparatuses, is mountable to a mobile object that has a deformable portion. The power receiving apparatus includes a power receiving antenna unit that includes a plurality of antenna sections. Each of the antenna sections is arranged to the mobile object while bypassing the deformable portion.

The power receiving antenna unit of the second exemplary aspect includes the antenna sections, and each of the antenna sections is arranged to the mobile object while bypassing the deformable portion of the mobile object.

As compared with a power receiving apparatus with a power receiving antenna unit that is arranged to the deformable portion of the mobile object, the power receiving apparatus of the second exemplary aspect makes it possible to suppress damage to the power receiving antenna unit caused by deformation of the mobile object.

### BRIEF DESCRIPTION OF THE DRAWINGS

Other aspects of the present disclosure will become apparent from the following description of embodiments with reference to the accompanying drawings in which:

FIG. 1 is a block diagram illustrating a schematic configuration of a wireless power transfer system according to the first embodiment of the present disclosure;

FIG. 2 is a perspective view of an AGV when the AGV is viewed from the bottom side thereof;

FIG. 3 is a view schematically illustrating a power receiving antenna unit when the AGV of the first embodiment is descending a step;

FIG. 4 is a view schematically illustrating a power receiving apparatus of the second embodiment when an AGV of the second embodiment is descending a step;

FIG. 5 is a view schematically illustrating a power receiving apparatus of the third embodiment when an AGV of the third embodiment is descending a step;

FIG. 6 is a view schematically illustrating a power receiving apparatus of the fourth embodiment when an AGV of the fourth embodiment is descending a step;

FIG. 7 is a view schematically illustrating a power receiving apparatus of the fifth embodiment when an AGV of the fifth embodiment is descending a step;

FIG. 8 is a view schematically illustrating a power receiving apparatus of the sixth embodiment when an AGV of the sixth embodiment is descending a step;

FIG. 9 is a view schematically illustrating a power receiving apparatus of the seventh embodiment when an AGV of the seventh embodiment is descending a step;

FIG. 10 is a view schematically illustrating a power receiving apparatus of the eighth embodiment when an AGV of the eighth embodiment is descending a step; and

FIG. 11 is a view illustrating a power receiving antenna unit according to a modification.

### DETAILED DESCRIPTION OF EMBODIMENTS

### First Embodiment

### Configuration of Wireless Power Transfer System

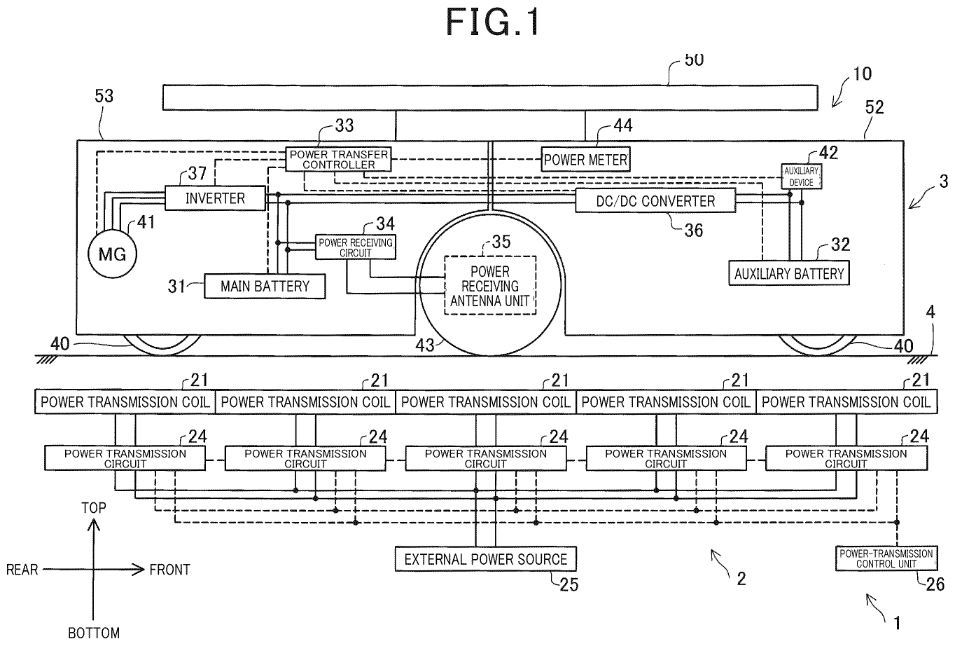

Referring to FIG. 1, a wireless power transfer system 1 includes a power transmission apparatus 2 mounted to a road 4, and a power receiving apparatus 3 mounted to an Automatic Guided Vehicle (AGV) 10. The wireless power transfer system 1 is configured such that the power transmission apparatus 2 is capable of wirelessly supplying power to the AGV 10 that is traveling or stopped.

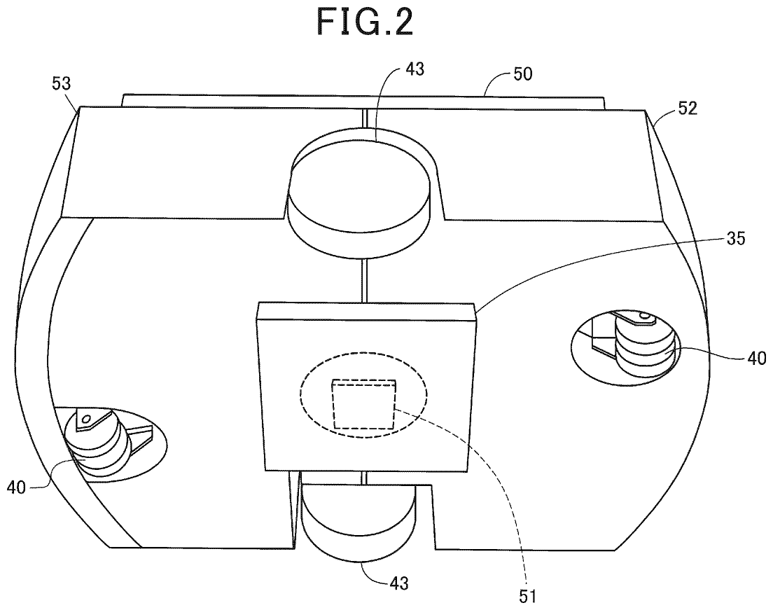

The AGV 10 of the first embodiment includes, as illustrated in FIG. 2, a front body 52, a rear body 53, a joint portion 51, a pallet 53, a pair of driving wheels 43, and a pair of steering wheels 40.

The AGV 10 is comprised of two separate bodies in its longitudinal direction; one of the two separate bodies located in front of the other thereof is the front body 52, and the other of the two separate bodies located in the rear of the front body 52 is the rear body 53. The joint portion 51 is configured to connect the front body 52 and the rear body 53 to one another, and serves as a joint in the AGV 10.

Specifically, the AGV 10 is configured to be deformable in the vertical direction about the joint portion 51 when ascending or descending a step or riding over an obstacle. More specifically, the AGV 10 is configured to be flexible convexly upward about the joint portion 51. This configuration of the AGV 10 enables the AGV 10 to continue stable traveling even when the AGV 10 is ascending or descending a step or riding over an obstacle.

The AGV 10 has a bottom, and a portion of the bottom, which is deformed, i.e., bent, when the AGV 10 is ascending or descending a step or riding over an obstacle, will be referred to as a deformable portion. The deformable portion of the AGV 10 may be deformed not only when the AGV 10 is moving but also when a floor on which the AGV 10 is stopped is moving.

On the pallet 53 of the AGV 50, various types of baggage are mountable.

The driving wheels 43 are mounted at respective left and right ends of the middle of the AGV 10 in its longitudinal direction. The driving wheels 43 are configured to operate based on drive power supplied from a motor-generator 41 described later to cause the AGV 10 to move in a forward direction or a rearward direction. The steering wheels 40 are mounted at respective front and rear ends of the middle of the AGV 10 in its left and right direction. The steering wheels 40 are configured to change the moving direction of the AGV 10.

The power transmission apparatus 2 mounted to the road 4 includes a plurality of power transmission coils 21, a plurality of power transmission circuits 24, an external power source 25, and a power-transmission control unit 26.

Each of the power transmission circuits 24 is configured to apply an alternating-current (AC) voltage to a corresponding one of the power transmission coils 21 to accordingly supply power to the corresponding one of the power transmission coils 21. The external power source 25 is configured to supply power to each of the power transmission circuits 24.

The power transmission coils 21 are arranged in a longitudinal direction of the road 4. The power transmission coils 21 are categorized into plural sectors.

Each of the power transmission circuits 24 is configured to convert a direct-current (DC) voltage supplied from the external power source 25 into a high-frequency AC voltage, and apply the converted AC voltage to the corresponding one of the power transmission coils 21. For example, each of the power transmission circuits 24 may be comprised of an inverter, a filter, and a resonance circuit. Because each of the inverter, filter, and resonance circuit is a well-known device, the descriptions of the inverter, filter, and resonance circuit will be omitted.

The external power source 25 is configured to supply the DC voltage to each power transmission circuit 24. For example, the external power source 25 includes a power-factor corrector (PFC), and is configured to receive grid power, and transmit the grid power through the PFC to each of the power supply circuits 24. Illustration of the PFC is omitted in FIG. 1. The DC voltage outputted from the external power source 25 is not limited to a complete DC voltage with no ripple, and can be a substantially DC voltage with certain levels of ripple.

The power-transmission control unit 26 is configured to control each power transmission circuit 24, so that each power transmission circuit 24 performs a power transmission operation through the corresponding power transmission coil 21.

The power receiving apparatus 3 includes a main battery 31, an auxiliary battery 32, a power transfer controller 33, a power receiving circuit 34, a power receiving antenna unit 35, a DC/DC converter 36, an inverter 37, a motor-generator 41, auxiliary devices 42, and a power meter 44.

The power receiving antenna unit 35 is configured to perform a power receiving process. Specifically, the power receiving antenna unit 35 includes a power receiving coil and a case that accommodates the power receiving coil.

In particular, the power receiving antenna unit 35 is mounted to the bottom of the joint portion 35, i.e., mounted across the deformable portion of the outer bottom surface of the AGV 10. The power receiving coil is configured to receive power supplied from the power transmission coil 21. The power receiving coil is comprised of, for example, a flexible wire. The case is comprised of, for example, a flexible resin member or a flexible metallic member. That is, the power receiving antenna unit 35 of the first embodiment has overall flexibility.

The power receiving coil is connected to the power receiving circuit 34, and outputs of the power receiving circuit 34 are connected to each of the main battery 31, high-side terminals of the DC/DC converter 36, and the inverter 37. Low-side terminals of the DC/DC converter 36 are connected to the auxiliary battery 32 and the auxiliary devices 42. The motor-generator 41 is connected to the inverter 37.

The power receiving circuit 34 includes a rectifier that converts an AC voltage outputted from the power receiving coil into a DC voltage. The power receiving circuit 34 may include a DC/DC converter that converts the DC voltage generated by the rectifier into a corrected DC voltage that is suitable for charging the main battery 31. The DC voltage outputted from the power receiving circuit 34 can be used to charge the main battery 31 and/or drive the motor-generator 41 through the inverter 37. The DC/DC converter 36 may be configured to step down the DC volage outputted from the power receiving circuit 34, and the stepped-down DC voltage can be used to charge the auxiliary battery 32 and/or drive the auxiliary devices 42.

The main battery 31 is a secondary battery for outputting a relatively high DC voltage for driving the motor-generator 41.

The motor-generator 41 operates as a three-phase AC motor that generates drive power for causing the vehicle 10 to travel. In addition, the motor-generator 41 operates as a generator that generates a three-phase AC voltage while the vehicle 10 is decelerating.

The inverter 37 is configured to convert the DC voltage outputted from the main battery 31 into the three-phase AC voltage when the motor-generator 41 serves as a three-phase AC motor, thus supplying the three-phase AC voltage to the motor-generator 41. In addition, the inverter 37 is configured to convert the three-phase AC voltage generated by the motor-generator 41 into a DC voltage when the motor-generator 41 serves as a generator, thus supplying the DC voltage to the main battery 31.

The DC/DC converter 36 is configured to step down the DC voltage based on the main battery 31, and supply the stepped-down DC voltage to both the auxiliary battery 32 and auxiliary devices 42. The auxiliary battery 32 is a secondary battery configured to output a DC voltage for driving the auxiliary devices 42. The auxiliary devices 42 include various accessory devices of the AGV 10, such as lighting devices of the AGV 10 and/or a lifting device for raising or lowering the pallet 50.

The power meter 44 is configured to measure the amount of power received by the power receiving coil. The amount of power measured by the power meter 44 can be displayed on a display device installed in the AGV 10 or can be transmitted from the power meter 44 to one or more computers, such as serves, installed outside the AGV 10.

### Deformation of Power Receiving Antenna Unit 35

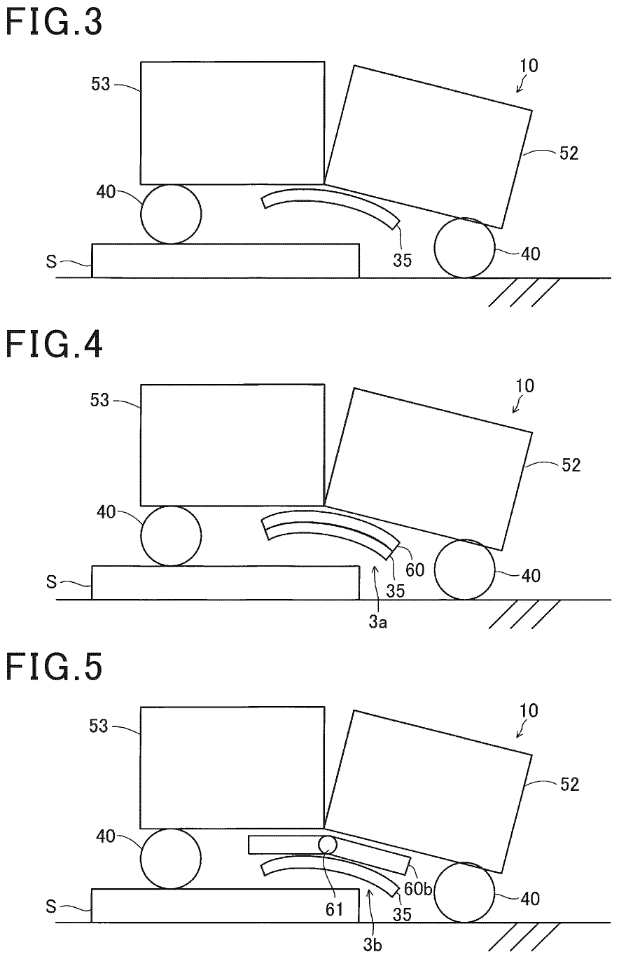

As illustrated in FIG. 3, when the AGV 10 descends a step S from the left side toward the right side of FIG. 3, the AGV 10 is deformed in the vertical direction around the joint portion 51. In other words, the AGV 10 bends in a manner convex upward about the joint portion 51. For the sake of convenience in illustration, FIG. 3 omits components other than the front body 52, the rear body 53, the steering wheels 40, and the power receiving antenna unit 35.

As described above, the power reception antenna unit 35 has overall flexibility and is mounted across the deformable portion of the AGV 10. The power receiving antenna unit 35 is configured to be at least partly deformable in accordance with the deformation of the AGV 10. Accordingly, even when the power receiving antenna unit 35 is mounted across the deformable portion, the configuration of the AGV 10 makes it possible to suppress damage to the power receiving antenna unit 35 caused by the deformation of the AGV 10.

The power receiving antenna unit 35 of the AGV 10 according to the first embodiment is mounted across the deformable portion of the AGV 10 and has flexibility. That is, the power receiving antenna unit 35 is at least partially deformable in accordance with deformation of the AGV 10. This therefore enables significant suppression of damage to the power receiving antenna unit 35 due to deformation of the AGV 10 as compared with the configuration that the power receiving antenna unit 35 has no flexibility.

The power receiving antenna unit 35 can be mounted across the deformable portion of the AGV 35, making it possible to prevent restrictions on the mount position of the power receiving antenna unit 35.

### Second Embodiment

A power receiving apparatus 3a according to the second embodiment includes, as illustrated in FIG. 4, a support member 60, which is different from the power receiving apparatus 3 of the first embodiment. Because the other configuration of the power receiving apparatus 3a of the second embodiment is identical to that of the power receiving apparatus 3 of the first embodiment, reference characters used for the components of the power receiving apparatus 3 are assigned to the same components of the power receiving apparatus 3a, and therefore the detailed descriptions for the same components of the power receiving apparatus 3a are omitted.

The support member 60 is, as illustrated in FIG. 4, arranged across the deformable portion of the bottom of the AGV 10, and is configured to support the power receiving antenna unit 35. The support member 60 is comprised of, for example, a flexible member, such as a flexible bracket, a flexible angle member, a flexible wire, or a flexible vibration suppression sheet, each of which can be manufactured by, for example, shaping a resin material. This therefore results in the support member 60 of the second embodiment has overall flexibility.

The support member 60 is configured to be at least partially deformable in accordance with deformation of the AGV 10. This suppresses damage to the support member 60 even if the support member 60 is mounted across the deformable portion of the AGV 10. Even if impact, such as significant vibration, is applied to the AGV 10, arrangement of the support member 60 between the power receiving antenna unit 35 and the AGV 10 suppresses impact to be applied to the power receiving antenna unit 35.

The power receiving apparatus 3a of the second embodiment achieves the same advantageous benefits as those achieved by the power receiving apparatus 3 of the first embodiment.

Additionally, the power receiving apparatus 3a of the second embodiment includes the support member 60 that supports the power receiving antenna unit 35, and the support member 60 has flexibility and is at least partially deformable in accordance with deformation of the AGV 10. This configuration therefore suppresses damage to the support member 60 when the AGV 10 is deformed.

Even if impact, such as significant vibration, is applied to the AGV 10, the power receiving apparatus 3a enables significant suppression of impact on the power receiving antenna unit 35 as compared with the configuration that the power receiving apparatus 3a has no support member 60.

### Third Embodiment

A power receiving apparatus 3b according to the third embodiment includes, as illustrated in FIG. 5, a support member 60b, which is different from the power receiving apparatus 3 of the first embodiment. Because the other configuration of the power receiving apparatus 3b of the third embodiment is identical to that of the power receiving apparatus 3 of the first embodiment, reference characters used for the components of the power receiving apparatus 3 are assigned to the same components of the power receiving apparatus 3b, and therefore the detailed descriptions for the same components of the power receiving apparatus 3b are omitted.

The support member 60b is, as illustrated in FIG. 5, mounted across the deformable portion of the bottom of the AGV 10, and is configured to support the power receiving antenna unit 35. The support member 60b is comprised of, for example, a bracket, an angle member, a wire, or a vibration suppression sheet.

Specifically, the support member 60b of the third embodiment, which differs from the support member 60 of the second embodiment, may not be necessarily comprised of a flexible member.

The support member 60b includes a joint portion 61. The joint portion 61 has a joint configuration where the support member 60b is deformable, i.e., bendable, in the vertical direction in accordance with deformation of the AGV 10. The joint portion 61 is comprised of, for example, one or more hinges, one or more ball joints, a gear structure, a link structure, or one or more joints. The joint portion 61 is not limited to these configurations, and may have any configuration that enables bending of the support member 60b. In FIG. 5, the single joint portion 61 is mounted over the deformable portion of the AGV 10, but plural joint portions 61 may be mounted over the deformable portion.

The power receiving apparatus 3b of the third embodiment achieves the same advantageous benefits as those achieved by the power receiving apparatus 3 of the first embodiment.

Additionally, the power receiving apparatus 3b of the third embodiment includes the support member 60b that supports the power receiving antenna unit 35, and the support member 60b includes the joint portion 61 that is at least partially deformable in accordance with deformation of the AGV 10. This configuration therefore suppresses damage to the support member 60 when the AGV 10 is deformed.

Even if impact, such as significant vibration, is applied to the AGV 10, the power receiving apparatus 3b enables significant suppression of impact on the power receiving antenna unit 35 as compared with the configuration that the power receiving apparatus 3b has no support member 60b.

### Fourth Embodiment

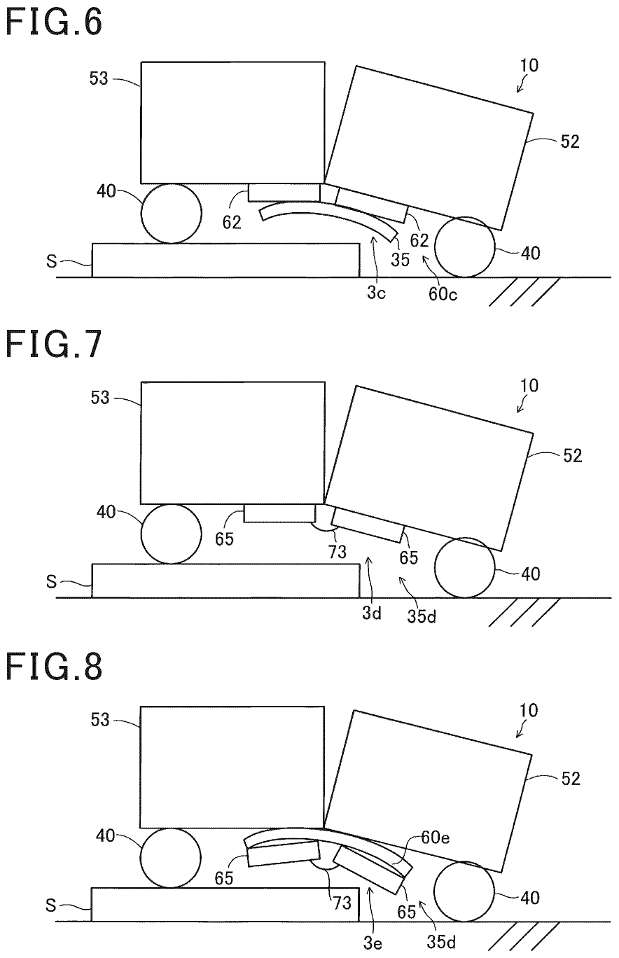

A power receiving apparatus 3c according to the fourth embodiment includes, as illustrated in FIG. 6, a support member 60c comprised of a plurality of support portions 62, which is different from the power receiving apparatus 3 of the first embodiment. Because the other configuration of the power receiving apparatus 3c of the fourth embodiment is identical to that of the power receiving apparatus 3 of the first embodiment, reference characters used for the components of the power receiving apparatus 3 are assigned to the same components of the power receiving apparatus 3c, and therefore the detailed descriptions for the same components of the power receiving apparatus 3c are omitted.

The support member 60c is, as illustrated in FIG. 6, mounted across the deformable portion of the bottom of the AGV 10, and is configured to support the power receiving antenna unit 35. The support member 60c is comprised of, for example, the support portions 62. The support portions 62 of the support member 60c are arranged to the bottom of the AGV 10 while bypassing the deformable portion of the AGV 10. In particular, FIG. 6 illustrates an example where two support portions 62 are mounted to the bottoms of the respective front and rear bodies 52 and 53 of the AGV 10, but the number of the support portions 62 is not limited to two. Specifically, three or more support portions 62 may be mounted to the bottom of the AGV 10. Each of the support portions 62 is comprised of, for example, a bracket, an angle member, a wire, or a vibration suppression sheet.

The power receiving apparatus 3c of the fourth embodiment achieves the same advantageous benefits as those achieved by the power receiving apparatus 3 of the first embodiment.

Additionally, the power receiving apparatus 3c of the fourth embodiment includes the support member 60c that supports the power receiving antenna unit 35, and the support member 60c is comprised of the support portions 62. The support portions 62 of the support member 60c are arranged to the bottom of the AGV 10 while bypassing the deformable portion of the AGV 10. This configuration therefore suppresses damage to the support member 60c when the AGV 10 is deformed.

Even if impact, such as significant vibration, is applied to the AGV 10, the power receiving apparatus 3c enables significant suppression of impact on the power receiving antenna unit 35 as compared with the configuration that the power receiving apparatus 3c has no support member 60c.

### Fifth Embodiment

A power receiving apparatus 3d according to the fifth embodiment includes, as illustrated in FIG. 7, a power receiving antenna unit 35d comprised of a plurality of antenna sections 65, and the antenna sections 65 are electrically connected to each other. These points are different from the power receiving apparatus 3 of the first embodiment. Because the other configuration of the power receiving apparatus 3d of the fifth embodiment is identical to that of the power receiving apparatus 3 of the first embodiment, reference characters used for the components of the power receiving apparatus 3 are assigned to the same components of the power receiving apparatus 3d, and therefore the detailed descriptions for the same components of the power receiving apparatus 3d are omitted.

Each of the antenna sections 65 includes a power receiving coil and a case that accommodates the power receiving coil. Although each of the power receiving coil and the case according to the first embodiment has flexibility, each of the power receiving coil and the case according to the fifth embodiment may not necessarily have flexibility.

The antenna sections 65 are arranged to the bottom of the AGV 10 while bypassing the deformable portion of the AGV 10. The antenna sections 65 are electrically connected to one another through at least one wire 73. The at least one wire 73 is comprised of, for example, a flexible material, such as copper.

In particular, FIG. 7 illustrates an example where two antenna sections 65 are mounted to the bottoms of the respective front and rear bodies 52 and 53 of the AGV 10, but the number of the antenna sections 65 is not limited to two. Specifically, three or more antenna sections 65 may be mounted to the bottom of the AGV 10.

The power receiving antenna unit 35d of the fifth embodiment is comprised of the antenna sections 65 arranged to the bottom of the AGV 10 while bypassing the deformable portion of the AGV 10. This configuration therefore enables further suppression of damage to the power receiving antenna unit 35d due to deformation of the AGV 10 as compared with the configuration that the power receiving antenna unit 35d is mounted to the deformable portion.

### Sixth Embodiment

A power receiving apparatus 3e according to the sixth embodiment includes, as illustrated in FIG. 8, a support member 60e, which is different from the power receiving apparatus 3d of the fifth embodiment. Because the other configuration of the power receiving apparatus 3e of the sixth embodiment is identical to that of the power receiving apparatus 3d of the fifth embodiment, reference characters used for the components of the power receiving apparatus 3d are assigned to the same components of the power receiving apparatus 3e, and therefore the detailed descriptions for the same components of the power receiving apparatus 3e are omitted.

The support member 60e is, as illustrated in FIG. 8, mounted across the deformable portion of the bottom of the AGV 10, and is configured to support the power receiving antenna unit 35d. Specifically, the support member 60e is configured to support the antenna sections 65 of the power receiving antenna unit 35d. Like the support member 60 of the second embodiment, the support member 60e is comprised of, for example, a flexible member, the support member 60e of the sixth embodiment has overall flexibility.

The power receiving apparatus 3e of the sixth embodiment achieves the same advantageous benefits as those achieved by the power receiving apparatus 3d of the fifth embodiment.

Additionally, the power receiving apparatus 3e of the sixth embodiment includes the support member 60e that supports the power receiving antenna unit 35d, and the support member 60e has flexibility and is at least partially deformable in accordance with deformation of the AGV 10. This configuration therefore suppresses damage to the support member 60e when the AGV 10 is deformed.

Even if impact, such as significant vibration, is applied to the AGV 10, the power receiving apparatus 3e enables significant suppression of impact on the power receiving antenna unit 35d as compared with the configuration that the power receiving apparatus 3e has no support member 60e.

### Seventh Embodiment

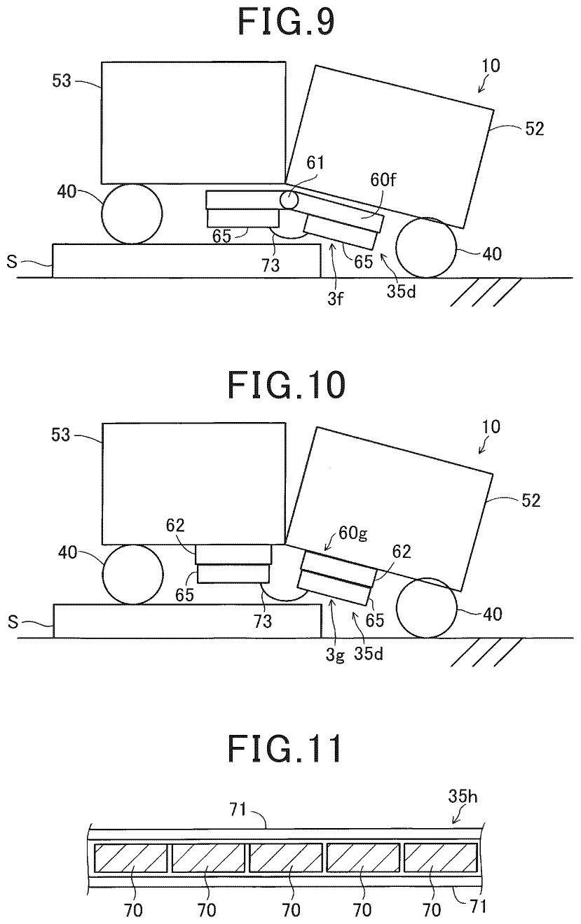

A power receiving apparatus 3f according to the seventh embodiment includes, as illustrated in FIG. 9, a support member 60f, which is different from the power receiving apparatus 3d of the fifth embodiment. Because the other configuration of the power receiving apparatus 3f of the third embodiment is identical to that of the power receiving apparatus 3 of the seventh embodiment, reference characters used for the components of the power receiving apparatus 3d are assigned to the same components of the power receiving apparatus 3e, and therefore the detailed descriptions for the same components of the power receiving apparatus 3e are omitted.

The support member 60f is, as illustrated in FIG. 9, mounted across the deformable portion of the bottom of the AGV 10, and is configured to support the antenna sections 65 of the power receiving antenna unit 35d. The support member 60f is comprised of, for example, a bracket, an angle member, a wire, or a vibration suppression sheet.

Specifically, the support member 60f of the seventh embodiment, which differs from the support member 60e of the sixth embodiment, may not be necessarily comprised of a flexible member.

The support member 60f includes a joint portion 61 like the support member 60b of the third embodiment. In FIG. 9, the single joint portion 61 is mounted over the deformable portion of the AGV 10, but plural joint portions 61 may be mounted over the deformable portion.

The power receiving apparatus 3f of the seventh embodiment achieves the same advantageous benefits as those achieved by the power receiving apparatus 3d of the fifth embodiment.

Additionally, the power receiving apparatus 3f of the seventh embodiment includes the support member 60f that supports the power receiving antenna unit 35d, and the support member 60f includes the joint portion 61 that is at least partially deformable in accordance with deformation of the AGV 10. This configuration therefore suppresses damage to the support member 60f when the AGV 10 is deformed.

Even if impact, such as significant vibration, is applied to the AGV 10, the power receiving apparatus 3f enables significant suppression of impact on the power receiving antenna unit 35d as compared with the configuration that the power receiving apparatus 3f has no support member 60f.

### Eighth Embodiment

A power receiving apparatus 3g according to the eighth embodiment includes, as illustrated in FIG. 10, a support member 60g comprised of a plurality of support portions 62, which is different from the power receiving apparatus 3d of the fifth embodiment. Because the other configuration of the power receiving apparatus 3g of the eighth embodiment is identical to that of the power receiving apparatus 3d of the fifth embodiment, reference characters used for the components of the power receiving apparatus 3d are assigned to the same components of the power receiving apparatus 3g, and therefore the detailed descriptions for the same components of the power receiving apparatus 3g are omitted.

The support member 60g is, as illustrated in FIG. 10, mounted across the deformable portion of the bottom of the AGV 10, and is configured to support the antenna sections 61 of the power receiving antenna unit 35d. The support member 60g is comprised of, for example, the support portions 62 like the support member 60c of the fourth embodiment. The support portions 62 of the support member 60g are arranged to the bottom of the AGV 10 while bypassing the deformable portion of the AGV 10. In particular, FIG. 10 illustrates an example where two support portions 62 are mounted to the bottoms of the respective front and rear bodies 52 and 53 of the AGV 10, but the number of the support portions 62 is not limited to two. Specifically, three or more support portions 62 may be mounted to the bottom of the AGV 10.

The power receiving apparatus 3g of the eighth embodiment achieves the same advantageous benefits as those achieved by the power receiving apparatus 3d of the fifth embodiment.

Additionally, the power receiving apparatus 3g of the eighth embodiment includes the support member 60g that supports the power receiving antenna unit 35d, and the support member 60g is comprised of the support portions 62. The support portions 62 of the support member 60g are arranged to the bottom of the AGV 10 while bypassing the deformable portion of the AGV 10. This configuration therefore suppresses damage to the support member 60g when the AGV 10 is deformed.

Even if impact, such as significant vibration, is applied to the AGV 10, the power receiving apparatus 3g enables significant suppression of impact on the power receiving antenna unit 35d as compared with the configuration that the power receiving apparatus 3g has no support member 60c.

### Modifications

The power receiving apparatuses 3, 3b, 3c, 3d, 3e, 3f, and 3g are mounted to the AGV 10, but the present disclosure is not limited thereto. Specifically, the power receiving apparatuses 3, 3b, 3c, 3d, 3e, 3f, and 3g may be mounted to any type of mobile object, which may not include a joint section 51.

The power receiving antenna unit of this modification, which is based on one of the power receiving antenna units 35 of the first to fourth embodiments and does not include a joint portion 51, may be mounted to a portion of the mobile object; the portion is likely to be deformed when the mobile object is ascending or descending a step S. The power receiving antenna unit of this modification, which is based on one of the power receiving antenna units 35d of the fifth to eighth embodiments and does not include a joint portion 51, may be mounted to the mobile object while bypassing the deformable portion of the mobile object. The deformable portion of any type of mobile object is located substantially at a center of the bottom of the mobile object in both the longitudinal direction and the lateral direction of the mobile object.

The deformable portion of each embodiment is a portion of the bottom of the AGV 10; the portion is likely to be deformed when the mobile object is ascending or descending a step or riding over an obstacle, but the present disclosure is not limited thereto.

The deformable portion of a mobile object may be located on a side or top of the mobile object. Examples of the deformable portion being located on a side of a mobile object include the coupling section between the driver's cabin and the chassis in a trailer as the mobile object, and the coupling section between cars in a train as the mobile object. The deformable portion located on a side of a trailer or a train is deformable, i.e., bendable, in a horizontal direction when the trailer or the train is turning. The power receiving antenna unit 35 or 35d is mounted to the bottom of the AGV 10, but may be mounted to the top or a side of a mobile object.

Each of the power receiving antenna units 35 and 35d according to any of the first to fourth embodiments is comprised of a flexible power receiving coil and a flexible case, so that the corresponding one of the power receiving antenna units 35 and 35d has overall flexibility, but the present disclosure is not limited thereto.

Specifically, a power receiving antenna unit 35h of this modification includes, as illustrated in FIG. 11, a plurality of separate coil segments 70 and a flexible film 71 that covers the coil segments 70. The coil segments 70 are electrically connected to one another through wires. This configuration of the power receiving antenna unit 35h of this modification enables the power receiving antenna unit 35h to be bent at the connection portions between the coil segments 70. This therefore results in the power receiving antenna unit 35h having overall flexibility.

Each of the power receiving antenna units 35, 35d, and 35h according to the corresponding one of the embodiments may be comprised of a shield and a ferrite core. The shield is configured to prevent electromagnetic waves from being transferred to devices other than the corresponding one of the power receiving antenna units 35, 35d, and 35h. The shield is, for example, formed of flexible metal, such as aluminum. The ferrite core is configured to adjust the inductance of the power receiving coil. The ferrite core is formed of a flexible magnetic material.

Each of the power receiving antenna units 35, 35d, and 35h according to the corresponding one of the embodiments includes the case. However, the present disclosure is not limited to the configuration. Specifically, each of the power receiving antenna units 35, 35d, and 35h according to the present disclosure may not include a case.

Any component other than the power receiving apparatus 35, 35d, or 35h of the corresponding one of the power receiving apparatuses 3, 3b, 3c, 3d, 3e, 3f, and 3g may be mounted to bypass the deformable portion.

The antenna sections 65 according to each of the fifth to eighth embodiments are electrically connected to one another through wires, but the present disclosure is not limited thereto. Specifically, each of the antenna sections 65 may be configured to wirelessly supply power. The wireless power transfer system 1 according to each embodiment is configured as a magnetic-coupling system that performs power transfer between the power transmission coils 21 and the power receiving coil. However, the present disclosure is not limited to the above configuration.

Specifically, the wireless power transfer system 1 according to the present disclosure may be configured as any power transfer system, such as an electric-field coupling system or an electromagnetic-wave reception system.

The wireless power transfer system 1, which is configured as an electric-field coupling system, may include, in place of the power transmission coils 21 and the power receiving coil, power transmission electrodes and a power receiving electrode. That is, each of the power receiving antenna units 35, 35d, and 35h may include at least the power receiving electrode. The power receiving electrode according to this modification may be comprised of a flexible member or a plurality of electrode segments.

The wireless power transfer system 1, which is configured as an electromagnetic-wave reception system, may include, in place of the power transmission coils 21 and the power receiving coil, power transmission antennas and a power receiving antenna. That is, each of the power receiving antenna units 35, 35d, and 35h may include at least the power receiving antenna. The power receiving antenna according to this modification may be comprised of a flexible member or a plurality of antenna segments.

The support portions 62 of each of the support members 60b and 60f of the corresponding one of the third and seventh embodiments may be connected to one another through joints 61.

The power receiving antenna unit 35 of each of the first to fourth embodiments has overall flexibility, but the present disclosure is not limited thereto. Specifically, the power receiving antenna unit 35 of the present disclosure may be configured to be at least partly flexible as long as it is at least partly deformable in accordance with deformation of the corresponding mobile object. The support member 60, 60e of each of the second and sixth embodiments has overall flexibility, but the present disclosure is not limited thereto. Specifically, the support member 60, 60e of the present disclosure may be configured to be at least partly flexible as long as it is at least partly deformable in accordance with deformation of the corresponding mobile object.

The present disclosure is not limited to the above embodiments, and can be implemented by various configurations within the scope of the present disclosure. For example, technical features included in the embodiments, which correspond to technical features included in the exemplary aspects described in the SUMMARY of the present disclosure, can be freely combined with each other or can be freely replaced with another feature in order to solve a part or all of the above issue and/or achieve a part or all of the above advantageous benefits. One or more of the technical features included in the above exemplary embodiments, which are not described as essential elements in the specification, can be omitted as necessity arises.

1. A power receiving apparatus to which power is to be wirelessly supplied from one or more power transmission apparatuses, the power receiving apparatus being mountable to a mobile object that has a deformable portion, the power receiving apparatus comprising:
a power receiving antenna unit mounted across the deformable portion of the mobile object, the power receiving antenna having flexibility, and being configured to be at least partly deformable in accordance with deformation of the mobile object.

2. The power receiving apparatus according to claim 1, further comprising:
a support member mounted to the mobile object and arranged across the deformable portion to support the power receiving antenna unit,
the support member having flexibility and being configured to be at least partly deformable in accordance with deformation of the mobile object.

3. The power receiving apparatus according to claim 1, further comprising:
a support member mounted to the mobile object to support the power receiving antenna unit,
the support member comprising a joint and being configured to be at least partly deformable in accordance with deformation of the mobile object.

4. The power receiving apparatus according to claim 1, further comprising:
a support member mounted to the mobile object to support the power receiving antenna unit,
the support member comprising a plurality of support portions,
each of the support portions being arranged to bypass the deformable portion of the mobile object.

5. A power receiving apparatus to which power is to be wirelessly supplied from one or more power transmission apparatuses, the power receiving apparatus being mountable to a mobile object that has a deformable portion, the power receiving apparatus comprising:
a power receiving antenna unit comprising a plurality of antenna sections,
each of the antenna sections being arranged to the mobile object while bypassing the deformable portion.

6. The power receiving apparatus according to claim 5, further comprising:
at least one flexible member,
the antenna sections being electrically connected to one another through the at least one flexible member.

7. The power receiving apparatus according to claim 5, further comprising:
a support member mounted to the mobile object and arranged across the deformable portion to support the power receiving antenna unit,
the support member having flexibility and being configured to be at least partly deformable in accordance with deformation of the mobile object.

8. The power receiving apparatus according to claim 5, further comprising:
a support member mounted to the mobile object to support the power receiving antenna unit,
the support member comprising a joint and being configured to be at least partly deformable in accordance with deformation of the mobile object.

9. The power receiving apparatus according to claim 5, further comprising:
a support member mounted to the mobile object to support the power receiving antenna unit,
the support member comprising a plurality of support portions,
each of the support portions being arranged to bypass the deformable portion of the mobile object.
